(19) United States
(12) Patent Application Publication
(10) Pub. No.: US 2011/0295686 A1
(43) Pub. Date: Dec. 1, 2011

(54) METHOD AND APPARATUS FOR MAINTAINING ADVERTISING LOGIC

(76) Inventor: Christine Gaelle Martin-Cocher, Toronto (CA)

(21) Appl. No.: 13/133,743

(22) PCT Filed: Dec. 10, 2009
(86) PCT No.: PCT/CA2009/001757

§ 371 Date: Aug. 17, 2011

Related U.S. Application Data
(60) Provisional application No. 61/121,420, filed on Dec. 10, 2008.

(51) Int. Cl. G06Q 30/00

(52) U.S. Cl. 705/14.49; 705/14.4

(57) ABSTRACT

A method and apparatus for tracking electronic advertisements for use with an electronic device and an ad server, the method comprising the steps of providing an ad client on the electronic device, modifying at least one ad reference such that a modified ad reference includes the ad client on an ad-link path, storing the modified ad reference on the electronic device, when an ad request is received from an application, the ad client providing the modified ad reference to the application, receiving an ad fetch request at the ad client directed along the ad-link path from the application and performing a function at the ad client in response to the fetch request.

### CROSS-REFERENCE TO RELATED APPLICATION

This application claims the benefit of the filing date of U.S. Provisional Patent Application No. 61/121,420 filed Dec. 10, 2008 under the title METHOD AND APPARATUS FOR MAINTAINING ADVERTISING LOGIC.

The content of the above patent application is hereby expressly incorporated by reference into the detailed description hereof.

### BACKGROUND

The present invention relates to a method and apparatus for tracking advertisements in communication systems that employ wireless electronic devices and for reducing the number of stale advertisements generated.

Advertisers are always looking for ways to customize advertisements for potential customers. Personal electronic devices have made customized advertising possible in ways never before contemplated. To this end, a web browser running on a portable electronic device such as a hand held computer, cell phone, etc., may track content viewed by a device user and use that information to customize advertisements presented to the user. In addition, when advertisement(s) are presented to a user via a browser or the like, the user's responses (i.e., selection of the advertisement, purchase of a good or service through an advertisement, etc.) to the advertisement(s) can be tracked and used to subsequently market other goods and/or services to the user. Moreover, costs for advertising can be assigned to specific advertisers where the extent of advertising and/or effectiveness of advertising can be tracked. Thus, an advertiser may be charged by the number of times an advertisement is presented to potential customers, the number of times potential customers click on an advertisement to obtain additional information, etc.

A typical electronic advertising system including electronic devices includes, in addition to the devices, an ad server and one or more content provider servers. The ad server stores and provides ads and ad references (e.g., network addresses) that can be used to access advertisements while content providers store content accessible to electronic devices. At least some electronic devices include a processor that runs one or more applications and an ad client or engine where the applications access and render advertisements for a user at different times during performance of the application. Alternatively some electronic devices include one or more ad-aware applications where each application is configured with advertisement logic. For instance, in the case of an application usable to access a video clip of a news story, in order to view the news story, a user may first be required to view an advertisement video clip presented by the application. In many cases the applications run advertisements that are at least somewhat related to content recently viewed via the device. In other cases where a device is position enabled (including a GPS, for example), ad content may be selected automatically by the device at least based on the current location of the device. Still further, ad content may be selected according to a user profile that defines the user's interests, demographics, etc.

The ad client or engine (hereinafter referred to as the ad client) performs several functions. First, the ad client periodically obtains ads from the ad server that can be provided to device applications when needed. Second, the ad client obtains ad requests from the applications along with, in at least some cases, request qualifier information indicating with some level of specificity qualifiers that can be used to select optimal advertisements to be presented via the application. For instance, where a user recently used the device to view a professional football team schedule and one possible advertisement has something to do with the team associated with the viewed schedule, the ad client may select the ad associated with the team to be presented via the application. Third, in many systems, the ad client may record and collect metrics related to which ads are presented to a user and the user's reactions to the ads, either based on assumptions or if an application notifies the ad client about the ad consumption. One example of the above method is described in the Open Mobile Alliance (OMA) Mobile Advertising (MobAd) Enabler.

In one type of electronic advertising system including a device with applications and an ad client, an ad server and an ad content provider, the ad server may receive and store a plurality of ad references to be presented to a user at subsequent times. Thereafter, when an application requests an ad, the ad client selects an appropriate ad reference, which was previously provided by the ad server, and provides that reference to the application. When the application receives the ad reference, the application uses the received ad reference to directly access the ad content provider to fetch the ad content which is then presented to the user via the device. Very often the ad reference includes a URL redirect pointing to the Ad server (also known in the industry as an ad network). When using the ad reference, the application first accesses the ad server that is in the path of the ad-link before being redirected to the Ad content source. To track “consumed ads” the ad client may be configured such that when an ad reference is requested, that the associated ad is considered to be consumed. The ad client may generate an ad client report (e.g., on a periodic, regular or other basis) which can be transmitted to the ad server or the like for subsequent billing, analysis, etc.

In another type of system ad content may be stored or cached locally on a portable device by the ad client. In this case, when an application requests an ad, the ad client selects an appropriate ad and provides that ad to the application which is then presented to the user via the device. Here, to track “consumed ads,” the ad client may be configured such that when ad content is provided to an application from its locally-stored or cached location, that the associated ad is considered to be consumed. Ad consumption may be reported in the form of an ad client report.

While conventional ad solutions are widely employed, these conventional solutions have several shortcomings. First, in many cases tracking ad consumption by counting the number of ad references provided to applications is inaccurate. To this end, not all ads associated with ad references provided to applications are either retrieved or presented by the application for viewing by a device user. For instance, where an application will need five advertisements during its operation and requests five ad references immediately upon commencement, the application may be cut short during operation (e.g., analogous to website abandonment) so that only a sub-set (e.g., 1 or 2 of the five ads) of the ads associated with the five references end up being viewed by a user or retrieved by the application. In this case, because the application bypasses the ad client when obtaining ad content from an external ad source such as an ad content provider or an ad repository, there is no way for the ad client to determine when ad content is actually obtained. Where the ad client reports five consumed ads because five ad references were provided to an application, the number of consumed ads reported may be erroneous.

Second, in many cases an application will request an ad reference, but will not immediately present the ad associated therewith. Here, if the content recently viewed by a device user changes between the time an ad reference is received by an application and the time at which the ad is retrieved, when the ad is finally presented, the subject matter of the ad will be completely unrelated to the current content and will likely be less interesting to the device user and therefore less likely to garner the user's attention as desired. For instance, where a user examines a professional football team schedule when an ad reference is initially provided to an application but an associated football advertisement is presented later when the user is using the device to browse for a deal on a new bedroom set, the football advertisement will be less interesting to the user at the later time and likely will not have the desired effect. Another instance, when an application requests an ad while a device is at one location near a restaurant and receives an ad reference for an ad associated with the restaurant, if the ad is only presented at a subsequent time when the device is no where near the restaurant, the ad content may be stale.

Third, in many cases an application and an ad client have a tight coupling and it is very likely that an assumption made by the Ad Client about the usage of ad references will be correct. However, when an ad client is not tightly coupled to an application (e.g., where an ad client serves a multitude of applications provided by various application developers/providers), the assumption that ads associated with received ad references are all retrieved and presented is relatively less accurate.

Thus, there is a clear need for a system that better tracks user interaction when references to ads are provided prior to actual ad consumption and to ensure that ads remain well targeted to users based on recent device activities (e.g., location, recently viewed content, etc.). There is also a need for a system that optimizes device and bandwidth resources by allowing content retrieval when relevant ads to be retrieved remain valid (i.e., where the ads are not stale or timed out).

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example advertisement/communication system;

FIG. 2 illustrates components that make up an exemplary user agent of FIG. 1;

FIG. 3 illustrates exemplary components that comprise the ad client of FIG. 2;

FIG. 4 illustrates an example message flow and activities where an ad client modifies ad references to include the ad client in an ad link path;

FIG. 5 illustrates an example where an ad server modifies ad references;

FIG. 6 illustrates an example message flow and processes whereby an ad client performs functions relative to staleness of an ad reference; and

FIG. 7 illustrates an example message flow and processes where an ad client fetches and stores ad content with long validity durations to expedite presentation of ads to a user agent device.

### DETAILED DESCRIPTION

The various aspects of the subject invention are now described with reference to the accompanying drawings. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

Some embodiments of the disclosure include a method for tracking electronic advertisements for use with an electronic device and an ad server, the method comprising the steps of providing an ad client on the electronic device and, at the ad client, modifying at least one ad reference to provide a modified ad reference where the modified ad reference includes the ad client on an ad-link path, using the ad client to store the modified ad reference, when an ad request is received from an application, the ad client providing the modified ad reference to the application, receiving an ad fetch request at the ad client directed along the ad-link path from the application and performing a function at the ad client in response to the fetch request.

In some cases the step of modifying at least one ad reference includes the ad client receiving the at least one ad reference from the ad server at the ad client and modifying the at least one ad reference to include the ad client on an ad-link path. In some cases the step of performing a function includes storing an indication that an ad associated with the modified ad reference has been fetched.

Some methods are also for use with an ad content provider, the method further including the step of, after receiving an ad fetch request directed along the ad-link path from the application, the ad client passing on the ad fetch request to the ad content provider. Some embodiments further including the step of, for at least one of the ad references received from the ad server, retrieving associated ad content from an ad content provider and storing the ad content on a local device memory, the step of modifying the at least one ad reference further including modifying the at least one ad reference to identify the storage location of the ad content stored on the local device memory.

In some embodiments one or more ad references of at least a subset of the ad references is associated with unique validity duration values indicating the period over which an ad reference remains valid, the method further including the steps of, prior to providing the ad reference, verifying if the ad reference duration value is valid.

In some embodiments one or more ad references of at least a subset of the ad references is associated with unique validity duration values indicating the period over which an associated ad reference remains valid, an associated ad remains valid, the method further including the steps of, prior to retrieving associated ad content, identifying an associated ad reference associated with a validity duration value that is greater than a threshold value, the step of retrieving associated ad content including retrieving ad content associated with at least one of the ad references that has a validity duration value that is greater than the threshold value.

In some cases one or more of the ad references of at least a subset of the ad references is associated with unique qualifiers that can be used to determine the genericness of an associated ad, the method further including the steps of, prior to retrieving associated ad content, identifying an ad reference associated with a unique qualifier that indicates that an associated ad is generic, the step of retrieving associated ad content including retrieving ad content associated with a generic ad. In some cases the ad reference is provided with additional information that includes at least one of an ad time validity, at least one ad qualifier, an ad reference time validity, a unique ad identifier and a unique ad reference identifier.

In some cases the step of receiving an ad fetch request includes receiving an ad fetch request that identifies the storage location of the ad content stored on a local memory. Some methods further include the step of, after providing the modified ad reference to the application, determining validity of the modified ad reference and, when the modified ad reference is determined to be invalid, performing a stale ad function.

In some embodiments at least one ad qualifier is associated with each of the ad references, the step of determining that a modified ad reference is still valid including analyzing conditions related to the ad qualifier. In some cases the step of performing a stale ad function includes at least one of replacing the modified ad reference with a valid ad reference, and providing an error message to the application that generated the ad request. In some cases the step of performing a function includes tracking and storing metrics associated with ad references. In some cases the step of modifying at least one ad reference includes the ad server modifying the at least one ad reference to include the ad client on an ad-link path.

In some cases the step of modifying at least one ad reference is performed by including at least one of the ad client and the ad server on an ad-link path or both.

Some embodiments include a method for tracking electronic advertisements for use with an electronic device and an ad content provider server, the method comprising the steps of providing an ad client on the electronic device, when an application on the electronic device generates an ad fetch request, routing the ad fetch request through the ad client to the content provider server and at the ad client, performing a function in response to reception of the ad fetch request. In some cases the step of performing a function includes one of storing metrics associated with the ad fetch request and determining that the fetch request is one of valid and invalid.

Other embodiments include an apparatus for tracking electronic advertisements for use with an electronic device and an ad server, the apparatus comprising a processor configured to perform the steps of modifying at least one ad reference to provide a modified ad reference where the modified ad reference includes the ad client on an ad-link path, an ad client processor on the electronic device configured to perform the steps of storing the modified ad reference, when an ad request is received from an application, providing the modified ad reference to the application, receiving an ad fetch request directed along the ad-link path from the application and performing a function in response to the fetch request, wherein the function includes one of storing metrics associated with the ad fetch request and determining that the fetch request is one of valid and invalid.

In some cases the ad client processor is configured to perform the step of modifying at least one ad reference by receiving the at least one ad reference from the ad server and modifying the at least one ad reference to include the ad client on an ad-link path. In some cases the ad client processor is configured to perform the step of performing a function by storing an indication that an ad associated with the modified ad reference has been fetched.

Some apparatus are also for use with an ad content provider, the ad client processor being configured to perform the step of, after receiving an ad fetch request directed along the ad-link path from the application, passing on the ad fetch request to the ad content provider. In some cases the ad client processor is further configured to perform the step of, for at least one of the ad references received from the ad server, retrieving associated ad content from an ad content provider and storing the ad content on a local device memory, the ad client processor configured to perform the step of modifying the at least one ad reference by modifying the at least one ad reference to identify the storage location of the ad content stored on the local device memory.

In some cases the ad client processor is configured to perform the step of receiving an ad fetch request by receiving an ad fetch request that identifies the storage location of the ad content stored on a local memory. In some cases the ad client processor is further configured to perform the step of, after providing the modified ad reference to the application, determining validity of the modified ad reference and, when the modified ad reference is determined to be invalid, performing a stale ad function. In some cases at least one ad qualifier is associated with each of the ad references and the ad client processor is configured to perform the step of determining that a modified ad reference is still valid by analyzing conditions related to the ad qualifier.

In some cases the ad client processor is configured to perform the step of performing a stale ad function by at least one of replacing the modified ad reference with a valid ad reference and providing an error message to the application that generated the ad request In some cases the apparatus is for use in a system that includes an ad server that includes the processor that modifies the at least one ad reference to include the ad client on an ad-link path.

Still other embodiments include an apparatus for tracking electronic advertisements for use with an electronic device and an ad content provider server, the apparatus comprising an application on the electronic device, an ad client on the electronic device, an ad client processor configured to perform the steps of, when the application generates an ad fetch request, routing the ad fetch request through the ad client to the content provider server, and at the ad client, performing a function in response to reception of the ad fetch request, wherein the step of performing a function includes one of storing metrics associated with the ad fetch request and determining that the fetch request is one of valid and invalid.

Other embodiments include an apparatus for tracking electronic advertisements for use with an electronic device and an ad server, the apparatus comprising an ad server processor that modifies ad references to include an ad client on an ad-link path and that provides the modified ad references to electronic devices for subsequent retrieval of ad content associated with the ad references.

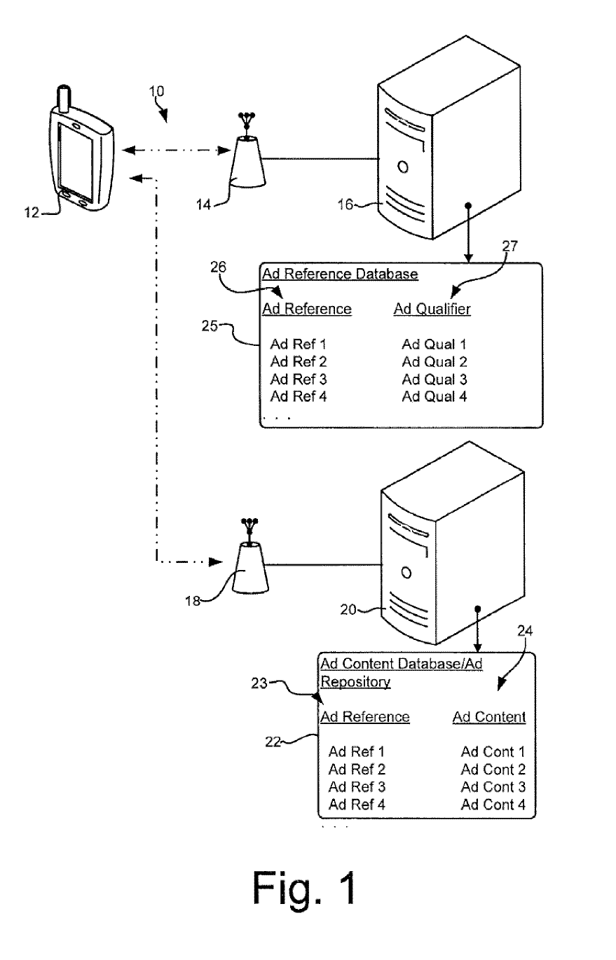

Referring now to the Figures, systems, methods and apparatuses for facilitating advertising are illustrated. As shown in FIG. 1, an exemplary communication system 10 includes a user agent 12, wireless network access devices 14, 18, an ad server 16 and an ad content provider server 20. User agent 12, also referred to as “UA”, may be a wireless device such as a mobile telephone, a personal digital assistant, handheld or lap top computers, or similar devices that have telecommunications capabilities. In some embodiments UA 12 may be a mobile wireless device. In other embodiments UA 12 may be a device that is not transportable such as a desktop computer, a set top box or a network node.

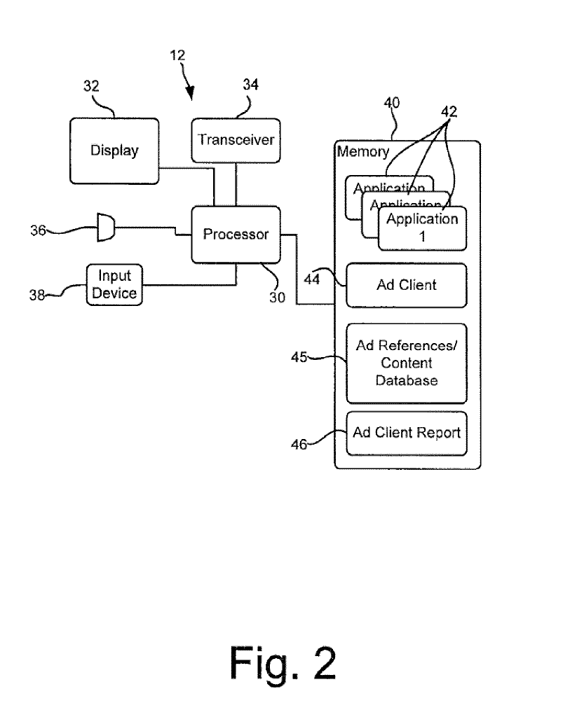

Referring now to FIG. 2, the components that comprise an exemplary UA 12 are illustrated. Exemplary UA 12 includes a processor 30, an electronic display device 32, a transceiver 34, an audio component 36, (e.g., a speaker), an input device 38 and a memory 40. Processor 30 is linked to display 32 and component 36 for providing output to a UA user. Some output to a user includes advertisements in the form of video clips and/or still images, virtual control and/or selection buttons for controlling advertisements, etc. Processor 30 is also linked to input device 38 for receiving input from a UA user. Input device 38 may take any of several different forms including a button or buttons, a switch or switches, a keyboard, trackball, roller wheel, etc., or virtual buttons presented on the display screen 32 that are selectable via a controlled cursor or by touching the electronic display device 32. Processor 30 is further linked to transceiver 34 and memory 40.

Processor 30 runs various application programs (hereinafter referred to interchangeably as applications, programs or application programs). Some of the application programs may include a communication program, an e-mail program, a web browser program, etc. Transceiver 34 enables wireless reception and transmission of data between UA 12 and access devices (e.g., 14 and 18 in FIG. 1).

Referring still to FIG. 2, memory 40 stores several different types of information including the applications collectively identified by reference numeral 42 that are run by processor 30. In addition, memory 40 stores an ad client 44, a local ad references/content database 45, and an ad client report 46. Ad client 44 will be described in greater detail below.

Referring again to FIG. 1, network access devices 14 are transponders or transceivers that receive wirelessly transmitted data from UA 12 and wirelessly transmit data and information to UA 12. Ad content provider server 20, as the label implies, includes a server that stores ad content including audio and video data that may be provided to UA 12 via access device 18. Ad content is stored in a data structure such as the ad content database/ad repository 22 shown in FIG. 1. Database/repository 22 is illustrated in table format in order to simplify this explanation. Nevertheless, it should be understood that the ad content database/ad repository 22 may take any form known in the art (e.g., relational database, lookup table, etc.) and, in many cases, may be more complex than the table database 22 illustrated.

Exemplary database 22 includes an ad reference column 23 and an ad content column 24. Ad reference column 23 lists references that can be used to access separate ads stored in database 22. Ad content column 24 includes a separate subset of ad content for each one of the ad references in column 23. Ad content includes data used to present audio and/or visual information to a UA 12 user and may include any format including text, graphics, etc. While database repository 22 is shown as separate from server 20 and, in some embodiments is simply managed by server 20, it should be appreciated that database/repository 22 may also be an integral part of server 20. Although only a single content provider server 20 is shown, it should be appreciated that a typical advertising and communication system 10 may include a large number of separate content provider servers 20 where each server 20 is maintained by a different advertising entity.

Referring still to FIG. 1, ad server 16 maintains an ad reference database 25 which stores a collection (e.g., an extensive list) of ad references in column 26 from a plurality of the ad content provider databases (e.g., see 22 in FIG. 1). Thus, for example, where there are a predetermined number of (e.g., one hundred) different ad content provider servers 20 and associated ad content databases, the ad reference database 25 may store all of the ad references from each of the ad content databases 22 that comprise the system 10. In addition to storing ad references, the ad reference database 25 may also store information that groups the ad references into different categories corresponding to different general topics such as sports, automobiles, water craft, building materials, hobbies, electronics, computer, etc. Moreover, database 25 may store information regarding how often ads associated with the ad references should be presented to UA users, times during which ads should be presented (e.g., three hour period before and including lunch hour), UA locations at which ads should be presented, periods during which ads remain valid (i.e., “validity durations” of the ads), etc. In FIG. 1, an ad qualifier column 27 lists ad qualifiers for each of the ad references in column 25 where the qualifiers may include one or more times to present ads, locations at which to present ads, content type, topics, etc.

In some embodiments databases 22 and 25 may be included in a single database. Moreover, Ad Ref 1 in database 22 and Ad Ref 1 in database 25 may be different ad references, Furthermore, in at least some embodiments, Ad Ref 1 in database 25 may contain Ad Server 16 on the ad path-link as well as the final destination of the content provider server 20.

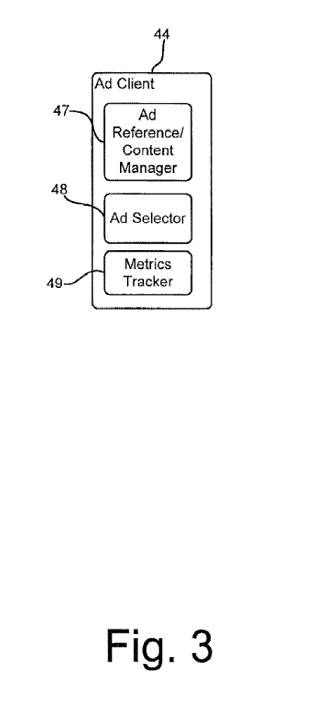

Referring now to FIG. 3, an exemplary ad client 44 is illustrated that includes an ad reference/content manager 47, an ad selector 48 and a metrics tracker 49. Ad reference manager 47, in at least some embodiments, maintains a list of ads and ad references that can be used by UA 12 to obtain ad content. Periodically, the reference/content manager 47 will request one or more ad references from ad server 16 and, when those references are obtained, potentially along with associated ad qualifiers from database 27, stores those references and associated qualifiers in the ad reference database 45 (see also FIG. 2) for subsequent use.

Ad client 44 receives ad requests from applications run by processor 30 and, ad selector 48 as the label implies, selects ads to present to a UA 12 user. The ad selector 48, in at least some embodiments, selects ads as a function of user activities performed most recently via the UA 12. Thus, for example, where a UA user recently accessed a professional football team schedule via the UA 12, ad selector 48 may select an advertisement related to sports or more specifically, an advertisement related to professional football or to the team associated with the schedule recently viewed. In addition, where UA 12 has positioning capabilities (e.g., by way of GPS or time and/or angle of arrival-based methods), ad selector 48 may select an ad to be presented to the UA user as a function of the substantially instantaneous location of the UA 12 when an application requests an ad. For instance, where a UA 12 is proximate a restaurant, the selector 48 may use the position of the UA 12 to select an ad that is to be presented when a UA is near the restaurant. Ad selector 48 may use many other types of data and situational information to select appropriate ads to be presented to the user.

Metrics tracker 49 tracks how many times specific ads are presented to a UA 12, how a UA user responds to an ad (e.g., did the user select an ad to obtain additional information, did the user ignore the ad, etc.) and other information. The metrics tracked by tracker 49 are used to create the ad client report 46 also known as a metric report shown in FIG. 2. The ad client report 46 is periodically transmitted from UA 12 to ad server 16 in FIG. 1 or to some other server that can use that report for ad billing purposes, assessing ad effectiveness, identifying user trends, etc.

Referring once again to FIGS. 1 and 2, in general, ad client 44 periodically requests ads from ad server 16. The ad server 16 returns ad references which, when received, are stored in the ad reference/content database 45. As processor 30 runs applications 42, periodically, those applications 42 are configured to present ads to the user of the UA 12 via display 32 and/or audio component 36. When an ad is to be presented, an application 42 requests an ad from ad client 44. The ad client 44 performs an ad selection operation and returns an ad reference to the application 42. The application 42 then uses the ad reference to obtain ad content associated with the ad reference from one of the content provider server 20 (or 16). Once the ad content is received by an application, the application presents the ad to the user.

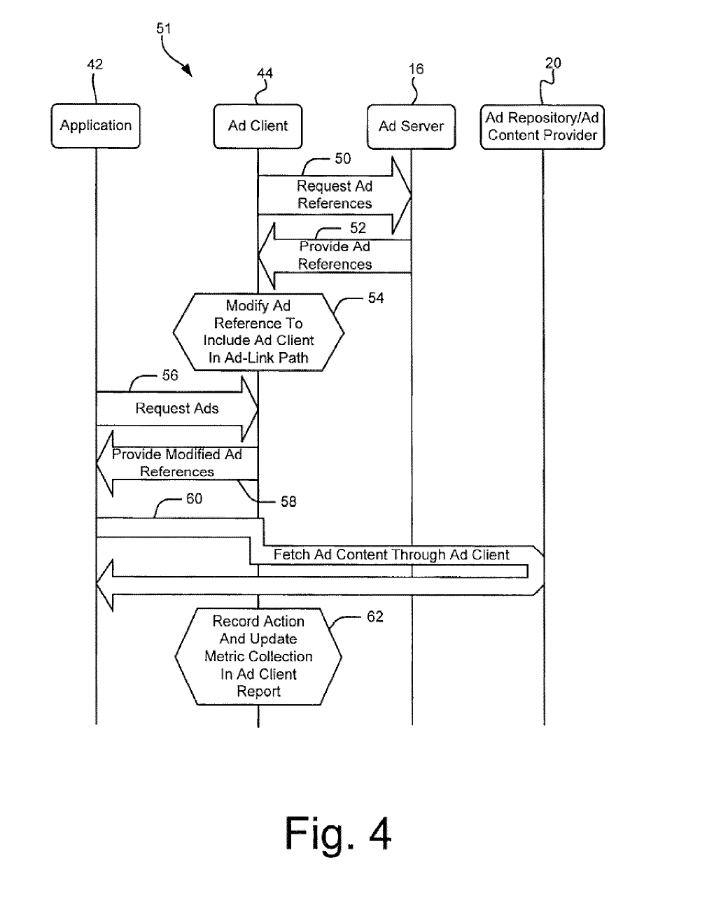

When an application uses an ad reference in an attempt to obtain ad content from a content provider, the ad-link path is passed through the ad client 44 and on to the content provider server 20 so that the metrics tracker 49 of the ad client 44 can accurately track ads presented via UA 12. To this end, an exemplary diagram 51 that illustrates one embodiment of a message flow between an application 42, the ad client 44, an ad server 16 and a content provider 20 is illustrated in FIG. 4. At step 50, ad client 44 requests either ads or references to ads from ad server 16. At step 52, the ad server 16 provides ad references to the ad client 44. At process block 54, ad client 44 modifies the ad reference to include the ad client in the ad-link path. Herein, the phrase “ad-link path” is used to refer to the communication path used by an application during a fetch activity for fetching ad content from the target source (e.g. an ad content provider). Thus, after the ad reference is modified at block 54, when the modified ad reference is subsequently used to fetch ad content, the fetch request is routed through the ad client which presents an opportunity for the ad client to perform some function in response to the fetch attempt. For example, according to at least one aspect of some embodiments of the disclosure, when an application uses the modified ad reference to attempt to obtain ad content from a content provider 20, the request for ad content is communicated through the ad client 44 to the content provider 20 enabling the metrics tracker 49 to recognize that the ad associated with the modified ad reference is being used by the application and is likely presented to the user.

Referring to FIG. 4, at step 56, application 42 requests one or more ads from the ad client 44. It is also possible that application 42 presents ad reference requests to ad client 44. The phrase “ad request” is used herein to mean either requests for ads or requests for ad references. At step 58, ad client 44 provides the modified ad references to application 42 in response to the request of step 56. At step 60, application 42 uses the modified ad references to fetch ad content. Here, the arrow associated with step 60 indicates that the fetch activity is routed through the ad client 44 and on to the content provider 20 which then returns the ad content to the application 42 to be used to present the associated ad. It is also possible that the fetch activity, after being routed through the ad client 44, is also routed through Ad Server 16 and on to the content provider 20. As shown at process block 62, when the ad client 44 receives the fetch command, in addition to passing the fetch command on to the content provider server 20, ad client 44 records the fetch action and updates the metric data in the ad client report 46 (FIG. 2). Thus, it can be appreciated that the application 42 can precisely track which ads are retrieved by the application 42 to be presented via the UA 12 to a user since the ad client 44 is configured to cooperate with the application 42 such that the application 42 cannot obtain ad content on its own.

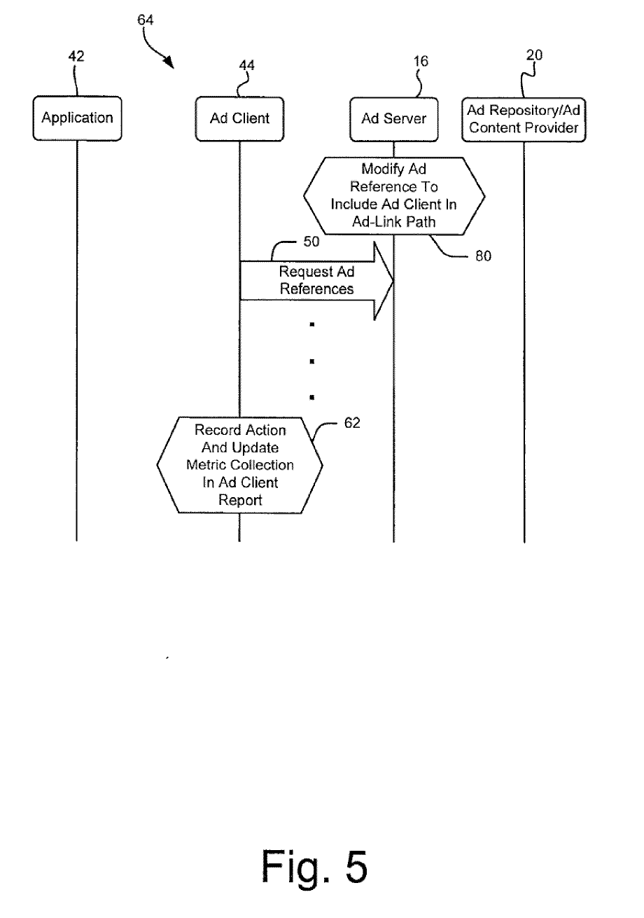

While FIG. 4 shows the ad client 44 modifying ad references to include the ad client in the ad-link path (see process block 54), in other embodiments the ad server 16 may modify ad references in a similar fashion to achieve a similar result. To this end, referring to FIG. 5, a portion of a sequence diagram 64 similar to the diagram 51 in FIG. 4 is illustrated where, at process block 80, ad server 16 modifies ad references to include the ad client 44 in the ad-link path prior to providing the ad references to the ad client 44. While modifying the ad-link path to include the ad client, the ad server may at that time, or previously, add into the ad-link path, the ad server in order to provide both a device and server side tracking of references that are used by the application and by the ad client. Thereafter, at step 50 when ad client 44 requests ad references from sever 16, the ad server provides the modified ad references to client 44 which are stored by client 44 for subsequent use. Thereafter, the process described above with respect to FIG. 4 including steps 56, 58, 60 and 62 is performed in the fashion described above so that fetch activities initiated by application 42 are routed through the ad client 44 and the fetch actions or activities can be recorded in the ad client 44 report at process block 62.

In some instances, modified ad references provided to an application 42 may become old or stale (i.e., invalid) between the time the ad reference is provided to the application and the time at which the application attempts to use the ad reference to obtain ad content. Thus, for example, where an application obtains an ad reference at a first time where the ad reference corresponds to an advertisement for a restaurant when a GPS enabled UA 12 is near the restaurant but does not fetch the ad content until a subsequent time when the UA 12 is nowhere near the restaurant, the restaurant advertisement may be stale and not particularly interesting to the user. Here, by routing an ad content fetch action through the ad client 44, the ad client can, essentially in real time, determine if an ad associated with the ad reference is stale. As another example, some ads are only to be provided at certain times. For instance, a restaurant owner may only want to provide a lunch advertisement between 10:00 a.m. and 1:00 p.m. on business days. Here, if an ad reference for lunch at the restaurant is obtained at 12:30 p.m. but is not used to fetch ad content until after 1:00 p.m., the ad reference may be stale or “timed-out.” Here, by routing the ad reference through ad client 44, the ad client 44 can determine whether or not the ad associated with the reference is stale and, if so, can perform a “stale ad” function.

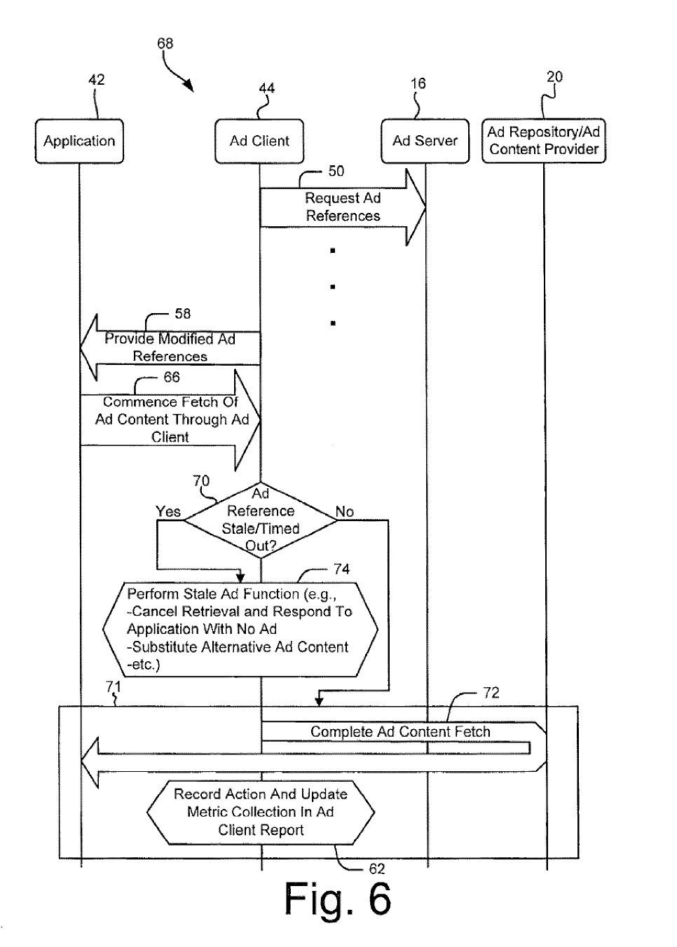

Referring now to FIG. 6, an exemplary diagram 68 is illustrated where the ad client 44 operates to eliminate or substantially reduce the possibility of presenting stale ads to a UA user. In FIG. 6, steps 50 through 58 whereby the ad client receives ad references and modifies those references to include the ad client in the ad-link path are similar to the steps described above with respect to FIG. 4 and therefore are not fully illustrated or described here in detail. After step 58, at step 66 the application 42 commences a fetch action to obtain ad content. The fetch is routed to ad client 44 at step 66. Once the fetch request is received by client 44, at decision block 70 the ad client 44 determines whether or not the ad associated with the ad reference is stale or timed out. Where the ad reference is not stale or timed out, control passes to process block 71 where, at 72, the ad client 44 completes the ad content fetch action and delivers the ad content to the application 42 for subsequent use. In addition, at 62 the ad client 44 records the action and updates the metric data in the ad client report. Referring again to decision block 70, where the ad reference is stale or timed-out, control passes to process block 74 where ad client 44 performs a “stale ad” function. Stale ad functions include, but are not limited to, canceling the fetch action and responding to the application 42 indicating that no ad will be provided or that an error has occurred, or substituting an alternative ad content for the requested ad reference. Where an alternative ad is to be presented, the ad client 44 may fetch the alternative ad content from a content provider 20 and provide that content to the application 42 in a manner similar to that described above with respect to step 72 or may retrieve it from the local cache or may provide a default ad.

According to yet another aspect of at least some embodiments of the present invention, ad client 44 may be configured to fetch ad content from a content provider prior to an ad request from an application 42 so that the ad content may be provided to the application 42 more quickly when requested. Whether or not ad content is fetched prior to reception of an ad request from an application may depend upon the state of the UA 12 and/or on communication bandwidth available for communications. For instance, ad client 44 may load advertisements for subsequent use when ad client 44 is physically linked to a laptop, when in a wifi/wimax network or when a UA battery is fully charged. In many cases there may be a long period between the time at which an ad client fetches ad content and when an application requests an ad with the corresponding characteristics (qualifier) such that ad content that may go stale relatively quickly may not be useable in many cases. For this reason, according to another aspect of at least some embodiments of the present invention, ad client 44 may be configured to fetch ad content for local storage that corresponds to ads that have relatively long periods prior to going stale (e.g., ads that have a “long validity duration”) and where the ads have fairly generic characteristics (e.g., where “sports” is a qualifier as opposed to “curling”). For ads with short validity duration, ad client 44 may store ad references locally to reduce the band width used to transfer ad information that is eventually unused. Where ad references are locally stored for ads that have short validity duration, ad content associated therewith may be accessed in the manner described above with respect to either of FIG. 4 or 5 if an application requests an ad prior to the ad going stale.

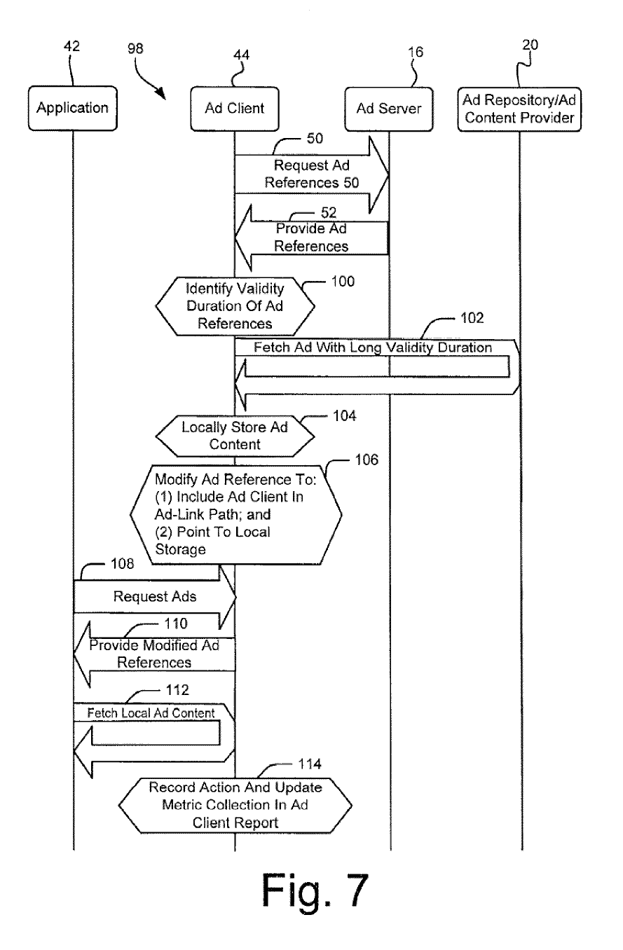

FIG. 7 illustrates yet another diagram 98 wherein the ad client 44 fetches and locally stores ad content that has long validity duration in order to, for example, speed up presentation of ads by applications. Additionally the ad client may be configured to fetch and locally-store ad content that has both a long validity duration and broad qualifiers. After ad references are requested and references and ad qualifiers (e.g., validity durations, topics) are provided at steps 50 and 52, at process block 100, ad client 44 identifies the validity duration of each of the ad references (e.g., via examination of the ad qualifiers). Ad client identifies ad references that have relatively long validity durations. Thus, in some cases the ad client will compare ad reference validity durations to a threshold value (e.g., 3 days) and identify ad references that have validity durations longer than the threshold value. At block 102, ad client 44 fetches ad content that has long validity duration from the content providers 20. The fetched ad content is stored at block 104. For ad references with short validity durations, those ad references may be stored by client 44 and used to obtain content subsequently if used prior to expiration of their validity duration periods. At process block 106, ad client 44 modifies or creates the ad references to fetched ads where the references include the ad client 44 in the ad-link path and to point to local storage (see again 45 in FIG. 2). At step 108, application 42 requests ads from ad client 44. At step 110, client 44 provides modified ad references to application 42. Depending on the ad reference provided, at step 112, application 42 fetches local ad content from ad client 44 (e.g., where the ad reference is associated with an ad having a long validity duration) or fetches ad content from an ad source (e.g. where the ad reference is associated with an ad having a short validity duration), via ad client 44 according to previous embodiments. At process block 114 ad client 44 records the fetch action and updates the metric data in the client report 46 (FIG. 2).

While the process described above with respect to FIG. 7 uses validity duration at steps 100 and 102 to select ad content to be retrieved prior to ad requests from an application, in some embodiments other factors may be used by the ad client to identify ads to retrieve early. For instance, in at least some embodiments, instead of or in addition to using validity durations to select ads for early retrieval, qualifier broadness or relative genericness may be employed. For instance, a qualifier “sports” is relatively more generic than “football” and a qualifier “football” is relatively more generic than “Texas football teams” and “Dallas Cowboys” is relatively specific. Here, the likelihood that an advertisement will remain valid for a longer duration may be related to the relative genericness or generality of the qualifier and therefore those qualifiers may be used in some cases to select ad content for early retrieval and local storage.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

Thus, the invention is to cover all modifications, equivalents, and alternatives falling within the spirit and scope of the invention as defined by the following appended claims. For example, while the ad server 16 and content provider server 20 are shown as two separate servers, in some contemplated systems a single server may provide functionality of the ad server and content provider server described above.

As another example, while an ad reference is modified at block 106 in FIG. 7 to point to local storage, in other embodiments it is contemplated that the ad reference may not be modified in this manner and instead, the ad client 44 may be configured to, when an ad fetch request is received at 112, correlate the request with local storage location.

As still one other example, referring again to FIG. 6, instead of ascertaining validity of an ad reference after a fetch request has been initiated at 66, ad client 44 may assess reference validity prior to step 66 and take preemptive steps to perform a stale ad function. For instance, when client 44 determines that an ad reference provided at step 58 is stale prior to fetch request 66, client 44 may provide a substitute ad reference to the application prior to step 66. As another example, client 44 may earmark a substitute ad reference in ad reference database 45 to be substituted for the stale reference in response to step 66. Here, one advantage is that the substitute ad reference may be selected as a function of content because there is sufficient time to attempt to identify a suitable ad reference prior to reception of a fetch request.

As another example, referring again to FIG. 6, application 42 may perform step 70 and if the ad reference is stale or timed out, application 42 may send another request for ads to ad client 44 thereby causing a process akin to the process 51 shown in FIG. 4, albeit where there is essentially no delay between steps 58 and 60.

Moreover, while at least some of the systems described above include an ad reference or ad validity duration, in fact in some cases there could be two separate duration values. For instance, there may be cases where an ad reference remains valid for a shorter time than the ad content referred to by the ad reference. In other cases an ad reference may be permanently valid, but the ad content may change over time on a link and may have a different time validity. In these cases other embodiments are included where ad reference duration and ad validity duration (i.e., an ad time validity) may be considered in a process similar to that described above with respect to FIG. 7.

1. A method for tracking electronic advertisements for use with an electronic device and an ad server, the method comprising the steps of:
modifying at least one ad reference such that a modified ad reference includes an ad client on an ad-link path;
storing the modified ad reference on the electronic device;
when an ad request is received from an application, the ad client providing the modified ad reference to the application;
receiving an ad fetch request from the application at a device processor, the ad fetch request being directed along an ad-link path that includes the ad client;
providing the ad fetch request to the ad client as specified by the ad-link path; and
in response to the ad fetch request, the ad client at least one of tracking metrics associated with ad references, storing metrics associated with ad references, and determining that the ad fetch request is one of valid and invalid.

2. The method of claim 1 wherein the step of modifying at least one ad reference includes the ad client receiving the at least one ad reference from the ad server at the ad client and modifying the at least one ad reference to include the ad client on an ad-link path.

3. The method of claim 1 wherein the steps of tracking or storing metrics includes storing an indication that an ad associated with the modified ad reference has been fetched.

4. The method of claim 1 also for use with an ad content provider, the method further including the step of, after receiving an ad fetch request directed along the ad-link path from the application, the ad client passing on the ad fetch request to an ad content provider.

5. The method of claim 2 further including the step of, for at least one of the ad references received from the ad server, retrieving associated ad content from an ad content provider and storing the ad content on a local device memory, the step of modifying the at least one ad reference further including modifying the at least one ad reference to identify the storage location of the ad content stored on the local device memory.

6. The method of claim 5 wherein each of at least a subset of the ad references are associated with unique validity duration values indicating the period over which an associated ad reference remains valid, the method further including the steps of, prior to retrieving associated ad content, identifying an ad reference associated with a validity duration value that is greater than a threshold value, the step of retrieving associated ad content including retrieving ad content associated with at least one of the ad references that has a validity duration value that is greater than the threshold value.

7. The method of claim 5 wherein the step of receiving an ad fetch request includes receiving an ad fetch request that identifies the storage location of the ad content stored on a local memory.

8. The method of claim 5 wherein each of at least a subset of the ad references are associated with unique qualifiers that can be used to determine the genericness of an associated ad, the method further including the steps of, prior to retrieving associated ad content, identifying an ad reference associated with a unique qualifier that indicates that an associated ad is generic, the step of retrieving associated ad content including retrieving ad content associated with a generic ad.

9. The method of claim 1 wherein the ad reference is provided with additional information that includes at least one of an ad time validity, at least one ad qualifier, an ad reference time validity, a unique ad identifier and a unique ad reference identifier.

10. The method of claim 1 wherein the ad reference contains the ad server in the ad path-link and wherein the step of modifying the ad reference adds the ad client to the ad-link path.

11. The method of claim 1 further including the step of, after providing the modified ad reference to the application, determining validity of the modified ad reference and, when the modified ad reference is determined to be invalid, performing a stale ad function.

12. The method of claim 9 wherein at least one ad qualifier is associated with each of the ad references, the step of determining that a modified ad reference is still valid including analyzing conditions related to the ad qualifier.

13. The method of claim 9 wherein the step of performing a stale ad function includes at least one of replacing the modified ad reference with a valid ad reference and providing an error message to the application that generated the ad request.

14. (canceled)

15. The method of claim 1 wherein the step of modifying at least one ad reference includes the ad server modifying the at least one ad reference to include the ad client on an ad-link path.

16. A method for tracking electronic advertisements for use with an electronic device including an application, and an ad content provider server, the method comprising the steps of:
when the application generates an ad fetch request that includes an ad-link path that includes an ad client, routing the ad fetch request through the ad client as specified by the ad-link path to the content provider server; and
at the ad client, in response to the ad fetch request, tracking or storing metrics associated with ad references and determining that the ad fetch request is one of valid and invalid.

17. (canceled)

18. An apparatus for tracking electronic advertisements for use with an electronic device and an ad server, the apparatus comprising:
a processor configured to perform the step of: modifying at least one ad reference to provide a modified ad reference such that the modified ad reference includes an ad client on an ad-link path;
an ad client processor on the electronic device configured to perform the steps of:
storing the modified ad reference;
when an ad request is received from an application, providing the modified ad reference to the application;
receiving an ad fetch request from the application where the ad fetch request is directed along an ad-link path that includes the ad-link client; and
in response to the ad fetch request, the ad client at least one of tracking metrics associated with ad references, storing metrics associated with ad references, and determining that the ad fetch request is one of valid and invalid.

19. The apparatus of claim 18 wherein the ad client processor is configured to perform the step of modifying at least one ad reference by receiving the at least one ad reference from the ad server and modifying the at least one ad reference to include the ad client on an ad-link path.

20. The apparatus of claim 18 wherein the ad client processor is configured to perform the step of performing a function by storing an indication that an ad associated with the modified ad reference has been fetched.

21. The apparatus of claim 18 also for use with an ad content provider, the ad client processor further configured to perform the step of, after receiving an ad fetch request directed along the ad-link path from the application, passing on the ad fetch request to the ad content provider.

22. The apparatus of claim 19 wherein the ad client processor is further configured to perform the step of, for at least one of the ad references received from the ad server, retrieving associated ad content from an ad content provider and storing the ad content on a local device memory, the ad client processor configured to perform the step of modifying the at least one ad reference by modifying the at least one ad reference to identify the storage location of the ad content stored on the local device memory.

23. The apparatus of claim 22 wherein the ad client processor is configured to perform the step of receiving an ad fetch request by receiving an ad fetch request that identifies the storage location of the ad content stored on a local memory.

24. The apparatus of claim 18 wherein the ad client processor is further configured to perform the step of, after providing the modified ad reference to the application, determining that the modified ad reference is one of valid and invalid and, when the modified ad reference is invalid, performing a stale ad function.

25. The apparatus of claim 24 wherein at least one ad qualifier is associated with each of the ad references, and the ad client processor is configured to perform the step of determining that a modified ad reference is still valid by analyzing conditions related to the ad qualifier.

26. (canceled)

27. The apparatus of claim 18 for use in a system that includes an ad server that includes the processor that modifies the at least one ad reference to include the ad client on an ad-link path.

28. An electronic advertising system comprising:
an ad server configured to store ad references;
an ad content provider configured to store ads corresponding to the ad references; and
a user agent device including an application and an ad client, the ad client receiving an ad request from the application and providing targeted advertising to the application for presentation to a user via the device;
wherein at least one of the ad client and the ad server modifies an ad reference to add the ad client to an ad-link path so that when the application invokes the ad reference to obtain an associated ad, an ad fetch request is delivered to the ad client.
